(19) United States
(12) Patent Application Publication
(10) Pub. No.: US 2018/0077738 A1
(43) Pub. Date: Mar. 15, 2018

(54) METHOD AND APPARATUS FOR ESTABLISHING APPLICATION SERVICE PLATFORM SESSION IN WIRELESS COMMUNICATION SYSTEM

(71) Applicant: LG ELECTRONICS INC., Seoul (KR)

(72) Inventors: Dongcheol KIM, Seoul (KR); Giwon PARK, Seoul (KR); Byungjoo LEE, Seoul (KR); Hyunhee PARK, Seoul (KR); Taesung LIM, Seoul (KR)

(73) Assignee: LG ELECTRONICS INC., Seoul (KR)

(21) Appl. No.: 15/559,217

(22) PCT Filed: Mar. 21, 2016
(86) PCT No.: PCT/KR2016/002815

§ 371 Date: Sep. 18, 2017

Related U.S. Application Data
(60) Provisional application No. 62/135,184, filed on Mar. 19, 2015.
(60) Provisional application No. 62/139,563, filed on Mar. 27, 2015.
(60) Provisional application No. 62/140,460, filed on Mar. 31, 2015.

(51) Int. Cl. H04W 76/02; H04W 80/10

(52) U.S. Cl. CPC H04W 76/02; H04W 84/12; H04W 80/10

(57) ABSTRACT

The present specification relates to a method for establishing, by a first device, an ASP session in a wireless communication system. The method for establishing, by a first device, an ASP session comprises the steps in which: the first device establishes, on the basis of a P2P connection method, an ASP session with a second device for a first service which is set to a first network type; the first device and the second device perform a feature capability exchange procedure; and the first device establishes an ASP session for a second service with the second device. Here, the feature capability exchange procedure may be completed when the first device transmits a feature capability request message to the second device on the basis of the established ASP session for the first service and receives a feature capability response message from the second device.

### TECHNICAL FIELD

The present specification relates to a wireless communication system, and more particularly, to a method of establishing an application service platform in a wireless communication system and an apparatus therefor.

### BACKGROUND ART

Wireless access systems have been widely deployed to provide various types of communication services such as voice or data. In general, a wireless access system is a multiple access system that may support communication of multiple users by sharing available system resources (e.g., a bandwidth, transmission power, etc.). For example, multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a multi carrier frequency division multiple access (MC-FDMA) system.

Recently, various wireless communication technologies have been developed with the advancement of information communication technology. Among the wireless communication technologies, a wireless local area network (WLAN) is the technology capable of accessing the Internet by wireless in a home, a company or a specific service provided area through portable device such as a personal digital assistant (PDA), a laptop computer, a portable multimedia player (PMP), etc. based on a radio frequency technology.

A standard for a WLAN (wireless local area network) technology is developing by IEEE (institute of electrical and electronics engineers) 802.11 group. IEEE 802.11a and b use an unlicensed band on 2.4 GHz or 5 GHz, IEEE 802.11b provides transmission speed of 11 Mbps and IEEE 802.11a provides transmission speed of 54 Mbps. IEEE 802.11g provides transmission speed of 54 Mbps by applying OFDM (orthogonal frequency division multiplexing) on 2.4 GHz. IEEE 802.11n provides transmission speed of 300 Mbps by applying MIMO-OFDM (multiple input multiple output-orthogonal frequency division multiplexing). IEEE 802.11n supports a channel bandwidth up to 40 MHz. In this case, transmission speed can be provided as fast as 600 Mbps. IEEE 802.11p corresponds to a standard for supporting WAVE (wireless access in vehicular environments). For instance, 802.11p provides improvement necessary for supporting ITS (intelligent transportation systems). IEEE 802.11ai corresponds to a standard for supporting fast initial link setup of IEEE 802.11 station.

A DLS (direct link setup)-related protocol in wireless LAN environment according to IEEE 802.11e is used on the premise of a QBSS (quality BSS) supporting QoS (quality of service) supported by a BSS (basic service set). In the QBSS, not only a non-AP STA but also an AP corresponds to a QAP (quality AP) supporting QoS. Yet, in current commercialized wireless LAN environment (e.g., wireless LAN environment according to IEEE 802.11a/b/g etc.), although a non-AP STA corresponds to a QSTA (quality STA) supporting QoS, most of APs corresponds to a legacy AP incapable of supporting QoS. Consequently, in the current commercialized wireless LAN environment, there is a limit in that a QSTA is unable to use a DLS service.

In a recent situation that such a wireless short-range communication technology as Wi-Fi and the like is widely applied to a market, connection between devices is performed not only based on a local network but also based on direct connection between devices. One of technologies enabling devices to be directly connected is Wi-Fi Direct.

Wi-Fi Direct corresponds to a network connectivity standard technology describing up to operations of a link layer. Since there is no definition on a regulation or a standard for an application of a higher layer, it is difficult to have compatibility and consistency of an operation after Wi-Fi Direct devices are connected with each other. For this reason, such a standard technology including higher layer application technology as WFDS (Wi-Fi Direct service) is under discussion by WFA (Wi-Fi alliance).

The WFA has announced such a new standard for delivering data via a direct connection between mobile devices as Wi-Fi Direct. Hence, related industries are actively developing a technology for satisfying the Wi-Fi Direct standard. In a strict sense, the Wi-Fi Direct is a marketing terminology and corresponds to a brand name. A technology standard for the Wi-Fi Direct is commonly called Wi-Fi P2P (peer to peer). Hence, the present invention describing Wi-Fi-based P2P technology may be able to use Wi-Fi Direct and Wi-Fi P2P without any distinction. In a legacy Wi-Fi network, a user accesses the legacy Wi-Fi network via an AP (access point) and accesses the Internet to use a device on which Wi-Fi is mounted. A data communication method via direct connection between devices is also used in a legacy communication by some users in a manner of being mounted on a device (e.g., a cellular phone, a note PC, etc.) on which a wireless communication technology such as Bluetooth is mounted. Yet, according to the data communication method, transmission speed is slow and transmission distance is limited to within 10 m. In particular, when the data communication method is used for transmitting massive data or is used in environment at which many Bluetooth devices exist, there exists a technical limit in performance capable of being felt by a user.

Meanwhile, Wi-Fi P2P maintains most of functions of the legacy Wi-Fi standard and includes an additional part for supporting direct communication between devices. Hence, the Wi-Fi P2P can sufficiently utilize hardware and physical characteristics of a device on which a Wi-Fi chip is mounted and is able to provide device-to-device P2P communication by upgrading a software function only.

As widely known, the device on which the Wi-Fi chip is mounted is extending to various ranges including a note PC, a smartphone, a smart TV, a game console, a camera and the like. For the device, sufficient numbers of suppliers and technology development personnel have been formed. Yet, software development supporting the Wi-Fi P2P standard is not vitalized yet. This is because, although a Wi-Fi P2P standard is announced, related software capable of conveniently using the Wi-Fi P2P standard is not distributed.

There exists a device playing a role of an AP in a legacy infrastructure network in a P2P group. The device is called a P2P group owner (GO) in a P2P standard. Various P2P clients may exist on the basis of the P2P GO. One GO exists in a single P2P group only and all remaining devices become client devices.

Recently, the use of Bluetooth, NAN (neighboring awareness networking), and NFC (near field communication) is increasing. Hence, it is necessary to have a method of providing a service in environment in which a plurality of systems or interfaces are provided.

### DISCLOSURE OF THE INVENTION

### Technical Tasks

One object of the present specification is to provide a method of establishing an ASP session in a wireless communication system and an apparatus therefor.

Another object of the present specification is to provide a method of establishing an ASP session based on a network type in a wireless communication system.

The other object of the present specification is to provide a method of exchanging information on a network type in a wireless communication system.

### Technical Solution

To achieve these and other advantages and in accordance with the purpose of the present invention, as embodied and broadly described, according to one embodiment, a method of establishing an application service platform (ASP) session, which is established by a first device in a wireless communication system, includes the steps of establishing an ASP session for a first service, which is configured by a first network type, with a second device based on a P2P connection method, performing a feature capability exchange procedure with the second device, and establishing an ASP session for a second service with the second device. In this case, the feature capability exchange procedure can be completed when the first device transmits a feature capability request message to the second device and receives a feature capability response message from the second device based on the established ASP session for the first service. In this case, the feature capability request message and the feature capability response message can include network type information on the second service.

To further achieve these and other advantages and in accordance with the purpose of the present invention, according to a different embodiment, a first device establishing an application service platform (ASP) session in a wireless communication system includes a reception module configured to receive information from an external device, a transmission module configured to transmit information to an external device, and a processor configured to control the reception module and the transmission module, the processor configured to establish an ASP session for a first service, which is configured by a first network type, with a second device based on a P2P connection method, the processor configured to perform a feature capability exchange procedure with the second device, the processor configured to establish an ASP session for a second service with the second device. In this case, the feature capability exchange procedure can be completed when the first device transmits a feature capability request message to the second device and receives a feature capability response message from the second device based on the established ASP session for the first service. In this case, the feature capability request message and the feature capability response message can include network type information on the second service.

Following items can be commonly applied to a method of establishing an application service platform (ASP) session, which is established by a first device in a wireless communication system, and an apparatus therefor.

The feature capability request message includes the network type information capable of being supported by the first device and the feature capability response message can include the network type information to be used by the second device based on the feature capability request message.

The feature capability request message and the feature capability response message can be performed in a state that a service discovery for the second service is completed.

A network type can be configured by either a first network type or a second network type. In this case, the network type can be determined based on whether or not the network type operates based on an IP (internet protocol).

The feature capability request message and the feature capability response message may correspond to messages which are defined based on an ASP coordination protocol (ASP CP) message format.

If the network type information is included in a message, which is exchanged between the first device and the second device to establish the ASP session for the second service, the feature capability exchange procedure can be omitted.

In this case, the message exchanged to establish the ASP session may correspond to either a version message or a session request message.

The ASP session for the second service can be established based on either the P2P connection method or a WLAN infrastructure connection method.

If the ASP session for the second service is established based on the WLAN infrastructure connection method, the first device and the second device omit additional authentication and an association procedure and can establish the ASP session for the second service based on the feature capability exchange procedure.

The method can further include the step of establishing an ASP session for a third service with a third device as a second network type based on the P2P connection method.

In this case, the first device may correspond to a P2P group owner device.

The first device can transmit a message including information on the network type to the second device and the third device before the ASP session for the first service and the ASP session for the third service are established.

The first device can perform a negotiation procedure for determining the network type with each of the second device and the third device before the ASP session for the first service and the ASP session for the third service are established.

The method can further include the step of establishing an ASP session for a third service with a third device as a second network type based on a WLAN infrastructure connection method.

### Advantageous Effects

According to the present specification, it is able to provide a method of establishing an ASP session in a wireless communication system and an apparatus therefor.

According to the present specification, it is able to provide a method of establishing an ASP session based on a network type in a wireless communication system.

According to the present specification, it is able to provide a method of exchanging information on a network type in a wireless communication system.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

FIG. 1 is a diagram for an example of a structure of IEEE 802.11 system to which the present invention is applicable;

FIG. 2 is a block diagram for an example of operations of a communication system adopting access devices and wireless user devices;

FIG. 3 is a diagram for an example of a WFD (Wi-Fi Direct) network;

FIG. 4 is a flowchart for an example of a process of configuring a WFD network;

FIG. 5 is a diagram for a typical P2P network topology;

FIG. 6 is a diagram for a situation that a single P2P device forms a P2P group and is connected with an AP in a manner of operating as an STA of WLAN at the same time;

FIG. 7 is a diagram for a WFD network aspect in case that P2P is applied;

FIG. 8 is a simplified block diagram for a WFDS (Wi-Fi Direct services) device;

FIG. 9 is a flowchart for a process of establishing a WFDS session by discovering a device and a service between WFDS devices in a legacy WFDS;

FIG. 10 is a diagram for a service application platform (ASP) supporting a plurality of interfaces;

FIG. 11 is a diagram of a method for a device to establish an ASP session based on a different ASP network type using a P2P connection;

FIG. 12 is a diagram of a method for a device to connect ASP network types different from each other using a different connection method;

FIG. 13 is a diagram of a method for a device to connect a different device using a P2P connection method and connect a different service using a different ASP network type;

FIG. 14 is a diagram of a method for a device to connect a different device using a different connection method and a different ASP network type for a different service;

FIG. 15 is a diagram for a method of establishing an ASP session;

FIG. 16 is a diagram for a method of establishing an ASP session when a different network type is set to a different service;

FIG. 17 is a diagram for a method of establishing an ASP session when a different network type is set to a different service;

FIG. 18 is a flowchart of a method for a device to support a service using an application service platform according to one embodiment of the present specification;

FIG. 19 is a block diagram for a device according to one embodiment of the present specification.

### BEST MODE

### Mode for Invention

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide the full understanding of the present invention. However, it will be apparent to those skilled in the art that the present invention may be implemented without such specific details.

The following embodiments can be achieved by combinations of structural elements and features of the present invention in prescribed forms. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment.

Specific terminologies in the following description are provided to help the understanding of the present invention. And, these specific terminologies may be changed to other formats within the technical scope or spirit of the present invention.

Occasionally, to avoid obscuring the concept of the present invention, structures and/or devices known to the public may be skipped or represented as block diagrams centering on the core functions of the structures and/or devices. In addition, the same reference numbers will be used throughout the drawings to refer to the same or like parts in this specification.

The embodiments of the present invention can be supported by the disclosed standard documents disclosed for at least one of wireless access systems including IEEE 802 system, 3GPP system, 3GPP LTE system, LTE-A (LTE-Advanced) system and 3GPP2 system. In particular, the steps or parts, which are not explained to clearly reveal the technical idea of the present invention, in the embodiments of the present invention may be supported by the above documents. Moreover, all terminologies disclosed in this document can be supported by the above standard documents.

The following embodiments of the present invention can be applied to a variety of wireless access technologies, for example, CDMA (code division multiple access), FDMA (frequency division multiple access), TDMA (time division multiple access), OFDMA (orthogonal frequency division multiple access), SC-FDMA (single carrier frequency division multiple access) and the like. CDMA can be implemented with such a radio technology as UTRA (universal terrestrial radio access), CDMA 2000 and the like. TDMA can be implemented with such a radio technology as GSM/GPRS/EDGE (Global System for Mobile communications)/General Packet Radio Service/Enhanced Data Rates for GSM Evolution). OFDMA can be implemented with such a radio technology as IEEE 802.11 (Wi-Fi), IEEE 802.16 (WiMAX), IEEE 802.20, E-UTRA (Evolved UTRA), etc.

Although the terms such as “first” and/or “second” in this specification may be used to describe various elements, it is to be understood that the elements are not limited by such terms. The terms may be used to identify one element from another element. For example, a first element may be referred to as a second element, and vice versa within the range that does not depart from the scope of the present invention.

In the specification, when a part “comprises” or “includes” an element, it means that the part further comprises or includes another element unless otherwise mentioned. Also, the terms “ . . . unit”, “ . . . module” disclosed in the specification means a unit for processing at least one function or operation, and may be implemented by hardware, software or combination of hardware and software.

For clarity, the following description focuses on IEEE 802.11 systems. However, technical features of the present invention are not limited thereto.

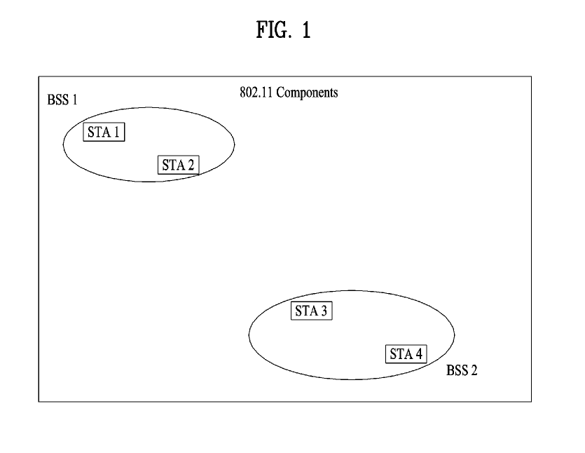

FIG. 1 is a diagram for an example of a structure of IEEE 802.11 system to which the present invention is applicable.

IEEE 802.11 structure can consist of a plurality of configuration elements and a WLAN supporting mobility of an STA, which is transparent to an upper layer, can be provided by interaction of a plurality of the configuration elements. A basic service set (hereinafter abbreviated BSS) may correspond to a basic configuration block in IEEE 802.11 LAN. FIG. 1 shows an example that there exist two BSSs (BSS 1 and BSS 2) and two STAs are included in each of the BSSs as members, respectively (STA 1 and STA 2 are included in the BSS 1 and STA 3 and STA 4 are included in the BSS 2). In this case, an STA indicates a device operating according to MAC (medium access control)/PHY (physical) standard of IEEE 802.11. An STA includes an AP (access point) STA (simply, an AP) and a non-AP STA. An AP corresponds to a device providing network access (e.g., WLAN) to a non-AP STA via a wireless interface. The AP can be configured by a fixed form or a mobile form and includes a mobile wireless device (e.g., a laptop computer, a smartphone, etc.) providing a hot-spot. The AP corresponds to a base station (BS), a Node-B, an evolved Node-B (eNB), a base transceiver system (BTS), a femto BS and the like in a different wireless communication field. The non-AP STA corresponds to a device directly controlled by a user such as a laptop computer, a PDA, a wireless modem, a smartphone and the like. The non-AP STA can be called a device, a wireless transmit/receive unit (WTRU), a user equipment (UE), a mobile station (MS), a mobile device, a mobile subscriber station (MSS), and the like.

An oval indicating a BSS in FIG. 1 may be comprehended as a coverage area of the STAs included in the BSS to maintain a communication. This area can be called a basic service area (hereinafter abbreviated BSA). A BSS of a most basic type in IEEE 802.11 LAN may correspond to an independent BSS (hereinafter abbreviated IBSS). For instance, the IBSS may have a minimum form consisting of two STAs only. The BSS (BSS 1 or BSS 2), which is the simplest form and omitted different configuration elements, in FIG. 1 may correspond to a representative example of the IBSS. This sort of configuration is available when the STAs are able to directly communicate with each other. And, this kind of LAN can be configured when a LAN is necessary instead of being configured in advance. Hence, this network may be called an ad-hoc network.

When power of an STA is turned on or turned off or an STA enters into a BSS area or gets out of the BSS area, a membership of the STA in a BSS can be dynamically changed. In order to be a member of the BSS, the STA can join the BSS using a synchronization process. In order to access all services based on a BSS structure, the STA can be associated with the BSS.

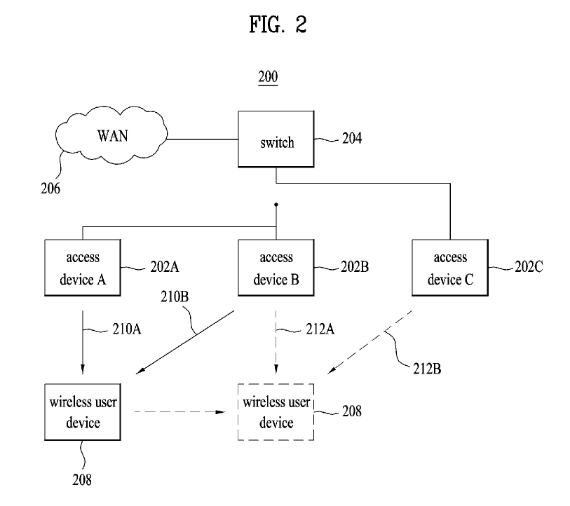

FIG. 2 is a block diagram for an example of a communication system 200 adopting access devices (e.g., AP STAs) 220A/202B/202C and wireless user devices (e.g., non-AP STAs).

Referring to FIG. 2, access devices 202A to 202C are connected with a switch 204 providing access to a WAN (wide area network) 206 such as the Internet. Each of the access devices 202A to 202C provides wireless access to wireless devices belonging to a coverage area (not depicted) of the access device via a time division multiplexed network. Hence, the access devices 202A to 202C commonly provide a total WLAN coverage area of the system 200. For instance, a wireless device 208 may exist in a coverage area of the access devices 202A and 202B in a position represented by a box of a line. Hence, the wireless device 208 can receive beacons from each of the access devices 202A/202B as shown by line arrows 210A and 210B. If the wireless device 208 roams to a dotted line box from the line box, the wireless device 208 enters a coverage area of the access device 202C and leaves a coverage area of the access device 202A. Hence, as shown by dotted lines 212A and 212B, the wireless device 208 can receive beacons from the access devices 202B/202C.

When the wireless device 208 roams in the total WLAN coverage area provided by the system 200, the wireless device 208 can determine which device provides best access to the wireless device 208. For instance, the wireless device 208 repeatedly scans beacons of adjacent access devices and may be able to measure signal strength (e.g., power) related to each of the beacons. Hence, the wireless device 208 can be connected with an access device providing optimal network access based on maximum beacon signal strength. The wireless device 208 may be able to use a different reference related to optimal access. For instance, the optimal access may be associated with more preferable services (e.g., contents, data rate and the like).

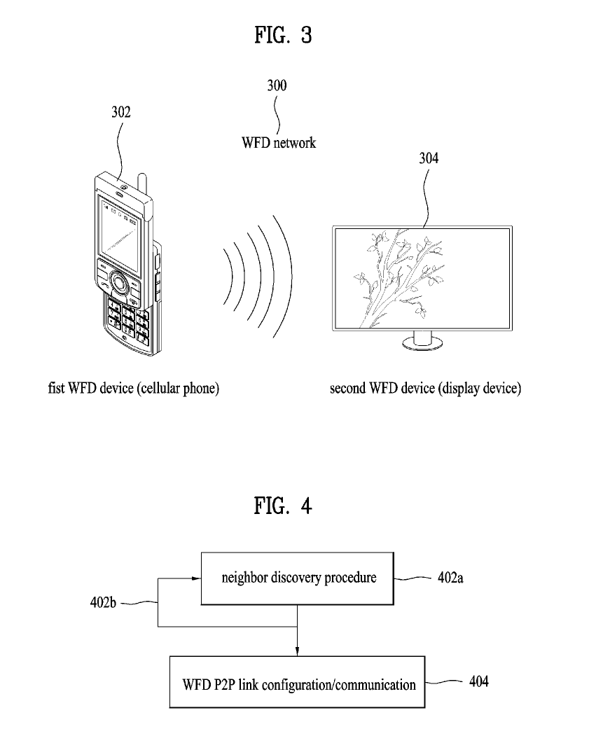

FIG. 3 is a diagram for an example of a WFD (Wi-Fi Direct) network.

A WFD network corresponds to a network capable of performing D2D (device-to-device) (or peer to peer (P2P) communication although Wi-Fi devices do not participate in a home network, an office network or a hot-spot network. The WFD network is proposed by Wi-Fi alliance. In the following, WFD-based communication is called WFD D2D communication (simply, D2D communication) or WFD P2P communication (simply, P2P communication). And, a device performing the WFD P2P communication is called a WFD P2P device, simply, a P2P device.

Referring to FIG. 3, a WFD network 300 can include at least one or more Wi-Fi devices including a first WFD device 302 and a second WFD device 304. A WFD device includes devices supporting Wi-Fi such as a display device, a printer, a digital camera, a projector, a smartphone and the like. And, the WFD device includes a non-AP STA and an AP STA. Referring to an example shown in the drawing, the first WFD device 302 corresponds to a smartphone and the second WFD device 304 corresponds to a display device. WFD devices in the WFD network can be directly connected with each other. Specifically, P2P communication may correspond to a case that a signal transmission path between two WFD devices is directly configured between the WFD devices without passing through a third device (e.g., an AP) or a legacy network (e.g., access WLAN via an AP). In this case, the signal transmission path directly configured between the two WFD devices may be restricted to a data transmission path. For instance, P2P communication may correspond to a case that a plurality of non-STAs transmit data (e.g., audio/image/text message information etc.) without passing through an AP. A signal transmission path for control information (e.g., resource allocation information for P2P configuration, wireless device identification information and the like) can be directly configured between WFD devices (e.g., between a non-AP STA and a non-AP STA, between a non-AP STA and an AP), between two WFD devices (e.g., between a non-AP STA and a non-AP STA) via an AP or between an AP and a corresponding WFD device (e.g., an AP and a non-AP STA #1, between an AP and a non-AP STA #2).

FIG. 4 is a flowchart for an example of a procedure of configuring a WFD network.

Referring to FIG. 4, a procedure of configuring a WFD network can be mainly divided into two procedures. A first procedure corresponds to a neighbor (device) discovery (ND) procedure [S402a] and a second procedure corresponds to a P2P link configuration and communication procedure [S404]. A WFD device (e.g., 302 in FIG. 3) finds out a different neighboring device (e.g., 304 in FIG. 3) in coverage (of the WFD device) via the neighbor discovery procedure and may be able to obtain information necessary for associating with the neighboring WFD device, e.g., information necessary for pre-association. In this case, the pre-association may indicate second layer pre-association in a wireless protocol. The information necessary for the pre-association can include identification information on the neighboring WFD device for example. The neighbor discovery procedure can be performed according to an available radio channel [S402b]. Subsequently, the WFD device 302 can perform a WFD P2P link configuration/communication procedure with the different WFD device 304. For instance, the WFD device 302 can determine whether the WFD device 304 corresponds to a WFD device not satisfying a service requirement of a user after the WFD device 302 is connected with the neighboring WFD device 304. To this end, the WFD device 302 is second layer pre-associated with the neighboring WFD device 304 and may be then able to search for the WFD device 304. If the WFD device 304 does not satisfy the service requirement of the user, the WFD device 302 disconnects the second layer connection established with the WFD device 304 and may be able to establish the second layer connection with a different WFD device. On the contrary, if the WFD device 304 satisfies the service requirement of the user, the two WFD devices 302/304 can transceive a signal with each other via a P2P link.

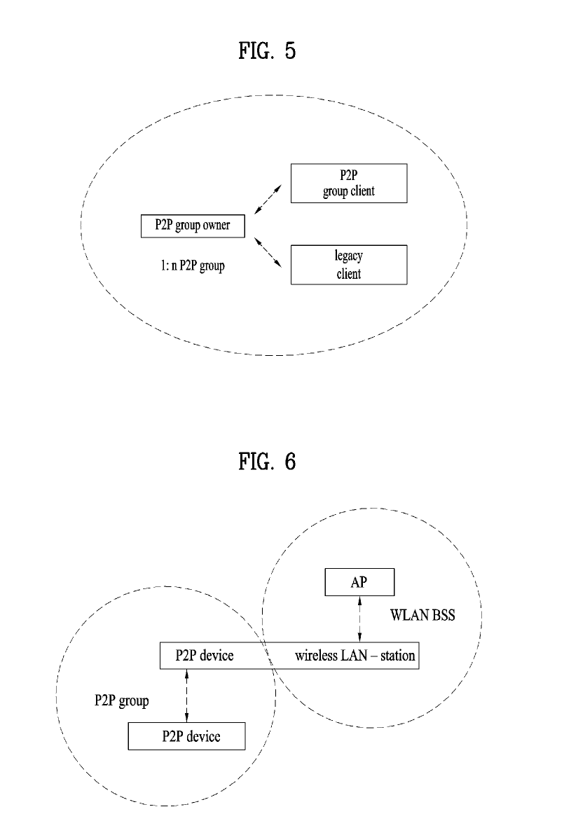

FIG. 5 is a diagram for a typical P2P network topology.

As shown in FIG. 5, a P2P GO can be directly connected with a client including a P2P function. Or, the P2P GO can be connected with a legacy client, which has no P2P function.

FIG. 6 is a diagram for a situation that a single P2P device forms a P2P group and is connected with an AP in a manner of operating as an STA of WLAN at the same time.

As shown in FIG. 6, according to P2P technical standard, a situation that a P2P device operates in the aforementioned mode is defined as a concurrent operation.

In order for a series of P2P devices to form a group, a P2P GO is determined based on a group owner intent value of a P2P attribute ID. The group owner intent value may have a value ranging from 0 to 15. P2P devices are exchanging the values and a P2P device including a highest value becomes the P2P GO. Meanwhile, in case of a legacy device not supporting the Wi-Fi P2P technology, although the legacy device can belong to a P2P group, a function of the legacy device is limited to a function of accessing an infrastructure network via the P2P GO.

According to Wi-Fi P2P standard, since a P2P GO transmits a beacon signal using OFDM (orthogonal frequency division multiplexing), a P2P device does not support 11b standard. Instead, 11a/g/n can be used as Wi-Fi P2P device.

In order to perform an operation of connecting a P2P GO and a P2P client with each other, a P2P standard mainly includes 4 functions described in the following.

First of all, P2P discovery is dealing with such a description entry as device discovery, service discovery, group formation and P2P invitation. According to the device discovery, 2 P2P devices exchange device-related information such as a device name of a counterpart device or a device type with each other via an identical channel. According to the service discovery, a service to be used and service-related information are exchanged with each other via P2P. According to the group formation, it corresponds to a function that a device to be a P2P GO is determined and a new group is formed. According to the P2P invitation, it corresponds to a function that a permanently formed P2P group is summoned or a function of making a P2P device join a legacy P2P group.

Secondly, P2P group operation explains P2P group formation and termination, connection to a P2P group, communication in a P2P group, a service for P2P client discovery, operation of a persistent P2P group and the like.

Thirdly, P2P power management is dealing with a method of managing power of a P2P device and a method of processing a signal on power saving mode timing.

Lastly, managed P2P device is dealing with a method of forming a P2P group in a single P2P device and a method of accessing an infrastructure network via a WLAN AP at the same time.

Characteristics of a P2P group are explained in the following. A P2P group is similar to a legacy infrastructure BSS (basic service set) in that a P2P GO plays a role of an AP and a P2P client plays a role of an STA. Hence, software capable of performing a role of a GO and a role of a client should be mounted on a P2P device. The P2P device is distinguished by using a P2P device address such as a MAC address. Yet, when the P2P device performs communication in a P2P group, the P2P device uses a P2P interface address. In this case, it is not necessary for the P2P device to use a single identifier (a globally unique ID) address. The P2P group includes a single identifier P2P group ID. The single identifier P2P group ID consists of a combination of an SSID (service set identifier) and a P2P device address. Wi-Fi P2P standard uses WPA2-PSK/AES for security. A life cycle of a P2P group has a temporary connection method and a persistent connection method for attempting an identical connection after prescribed time. In case of a persistent group, once a P2P group is formed, a role, a certificate, an SSID and a P2P group ID are cached. When connection is reestablished, connection of a group can be promptly established by applying an identical connection form.

In the following, Wi-Fi P2P connection method is explained. A Wi-Fi device mainly performs a connection procedure of two phases. First one corresponds to a phase that two P2P devices find out a counterpart device and a second one corresponds to a group formation phase for determining a role of a P2P GO or a role of a P2P client between discovered devices. First of all, the finding phase corresponds to a phase of connecting P2P devices with each other. In particular, the finding phase includes a search state and a listen state. The search state performs active search using a probe request frame. In this case, a range of the search is restricted for a quick search. For the quick search, such a social channel as a channel 1, 6 and 11 are used. A P2P device of the listen state maintains a reception state in a manner of selecting one channel from the 3 social channels. If the P2P device receives a probe request frame transmitted by a different P2P device of the search state, the P2P device transmits a probe response frame to the different P2P device in response to the probe request frame. P2P devices continuously repeat the search state and the listen state and may be able to arrive at a channel common to the P2P devices. The P2P devices find out a counterpart device and use a probe request frame and a probe response frame to selectively combine with the counterpart device and to discover a device type, a manufacturer, or a friendly device name. In order to check a service existing in the internal of the P2P devices and compatible between the devices, it may use the service discovery. The service discovery is used to determine whether a service provided in the internal of each device is compatible with a different device. According to the P2P standard, a specific service discovery standard is not designated. A user of a P2P device searches for a neighboring P2P device and a service provided by the P2P device and may be then able to connect with a device or a service preferred by the user.

As a second phase, a group formation phase is explained in the following. If a P2P device completes the aforementioned find phase, checking existence of a counterpart device is completed. Based on this, two P2P devices should enter a GO negotiation phase to configure a BSS. The negotiation phase is divided into two sub phases. One is a GO negotiation phase and another is a WPS (Wi-Fi protected setup) phase. In the GO negotiation phase, the two P2P devices negotiate a role of a P2P GO and a role of a P2P client with each other and an operation channel to be used in the internal of a P2P group is configured. In the WPS phase, such a usual job performed in a legacy WPS as exchanging PIN information inputted by a user using a keypad or the like, simple setup via a push button and the like is performed. In a P2P group, a P2P GO plays core role of the P2P group. The P2P GO assigns a P2P interface address, selects an operation channel of the group and transmits a beacon signal including various operation parameters of the group. In the P2P group, a beacon signal can be transmitted by the P2P GO only. A P2P device can quickly check the P2P GO using the beacon signal in a scan phase corresponding to a connection initial phase and performs a role of participating in the group. Or, the P2P GO can initiate a P2P group session by itself or may be able to initiate a session after the method mentioned earlier in the P2P finding phase is performed. Hence, since a value intended to be the P2P GO is controlled by an application or a higher layer service instead of a value fixed by a certain device, a developer can select an appropriate value, which is intended to be the P2P GO, according to a usage of each application program.

Subsequently, P2P addressing is explained in the following. A P2P device uses a P2P interface address in a manner of assigning a P2P interface address using a MAC address in a P2P group session. In this case, the P2P interface address of a P2P GO corresponds to a BSSID (BSS identifier). The BSSID practically corresponds to a MAC address of the P2P GO.

Connection release of a P2P group is explained in the following. If a P2P session is terminated, a P2P GO should inform all P2P clients of termination of a P2P group session via De-authentication. A P2P client can also inform the P2P GO of connection release. In this case, if possible, it is necessary to perform a disassociation procedure. Having received a connection release request of a client, the P2P GO can identify that connection of the P2P client is released. If the P2P GO detects a P2P client making a protocol error or performing an operation of interrupting connection of a P2P group, the P2P GO generates rejection of authentication or a denial of association. In this case, the P2P GO records a concrete failure reason on an association response and transmits the association response to the P2P client.

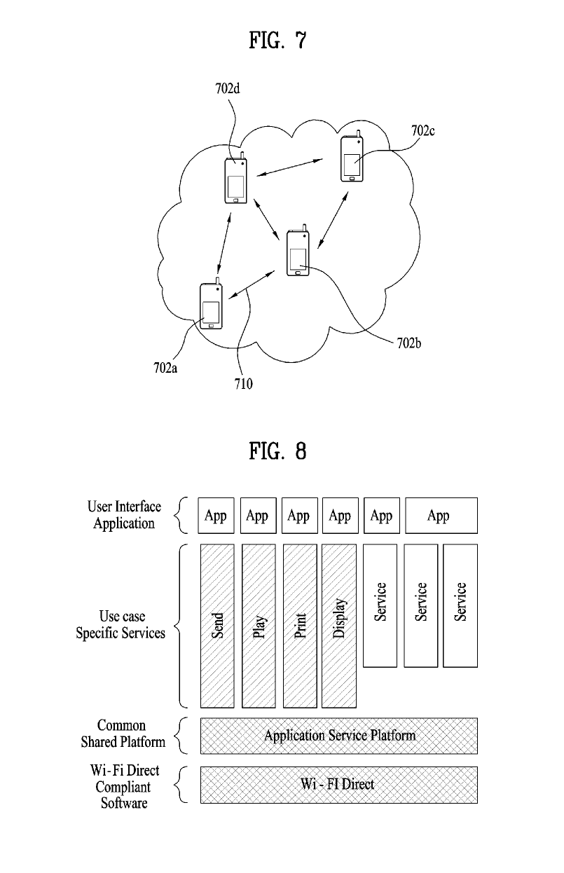

FIG. 7 is a diagram for a WFD network aspect in case that P2P is applied.

FIG. 7 shows an example of a WFD network aspect in case of applying a new P2P application (e.g., social chatting, location-based service provision, game interworking and the like). Referring to FIG. 7, a plurality of P2P devices 702a to 702d perform P2P communication 710 in a WFD network. P2P device(s) constructing the WFD network frequently change due to movement of the P2P device or the WFD network itself can be newly generated or disappeared dynamically/in a short time. Hence, characteristic of the new P2P application part is in that P2P communication can be performed and terminated dynamically/in a short time between a plurality of the P2P devices in dense network environment.

FIG. 8 is a simplified block diagram for a WFDS (Wi-Fi Direct services) device.

A platform for such an application service as an ASP (application service platform) is defined for a Wi-Fi Direct MAC layer and above. The ASP plays a role of session management, command processing of a service, control between ASPs and security between a higher application and a lower Wi-Fi Direct. 4 basic services including a Send service, a Play service, a Display service and a Print service defined by WFDS, a corresponding application and an UI (user interface) are supported at the top of the ASP. In this case, the Send service corresponds to a service capable of performing file transfer between two WFDS devices and an application therefor. The Play service corresponds to a streaming service capable of sharing A/V, a picture, and music based on a DLNA between two WFDS devices and an application therefor. The Print service defines a service capable of outputting a document and a picture between a device including contents such as a document, a picture and the like and a printer and an application therefor. The Display service defines a service enabling screen sharing between Miracast source of WFA and Miracast sink and an application therefor. And, an enablement service is defined for the use of an ASP common platform in case of supporting a third party application except a basic service.

Among terminologies described in the present invention, such a terminology as a service hash is formed from a service name using a first 6 octets of a service hash algorithm (e.g., SHA256 hashing) of a service name. A service hash used by the present invention does not mean a specific service hash. Instead, it may be preferable to comprehend the service hash as a sufficient representation of a service name using a probe request/response discovery mechanism. As a simple example, if a service name corresponds to “org.wifi.example”, 6 bytes of a forepart of a value of which the service name is hashed by the SHA256 corresponds to a hash value.

In WFDS, if a hash value is included in a probe request message and a service is matched with each other, it may be able to check whether the service is supported in a manner of responding by a probe response message including a service name. In particular, the service name corresponds to a name of a user readable service of a DNS form. A service hash value indicates upper 6 bytes among a value of 256 bytes of the service name generated by an algorithm (e.g., SHA256). As mentioned in the foregoing example, if a service name corresponds to “org.wifi.example”, a service hash may correspond to a value of “4e-ce-7e-64-39-49”.

Hence, a part of a value of which a service name is hashed by an algorithm is represented as a service hash (information) in the present invention. The service hash can be included in a message as information.

Method of Configuring Legacy WFDS

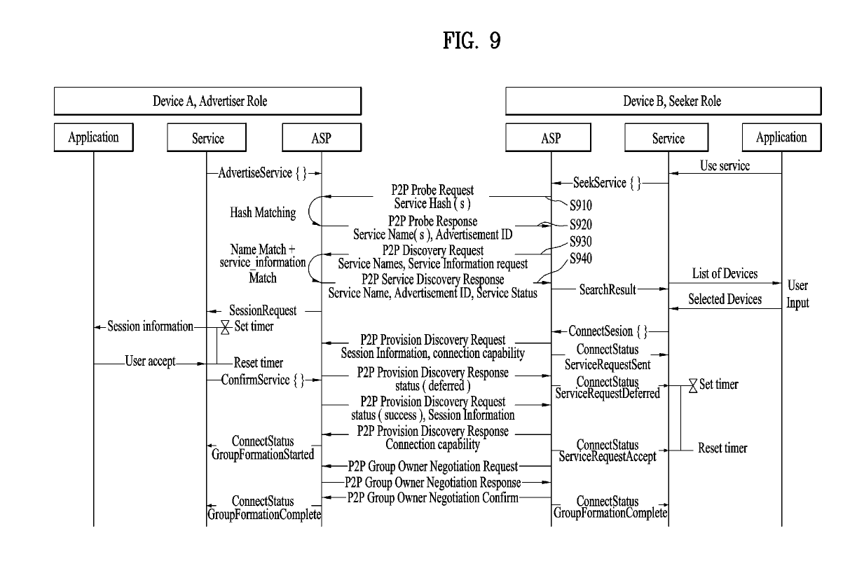

FIG. 9 is a flowchart for a process of establishing a WFDS session by discovering a device and a service between WFDS devices in a legacy WFDS.

For clarity, as shown in FIG. 4, assume that a device A plays a role of an advertiser advertising a WFDS capable of being provided by the device A to a seeker and a device B plays a role in seeking an advertised service. The device A corresponds to a device intending to advertise a service of the device A and a counterpart device intends to start the service in a manner of finding out the service of the device A. The device B performs a procedure of finding out a device supporting a service according to a request of a higher application or a user.

A service end of the device A advertises a WFDS capable of being provided by the service end to an application service platform (ASP) end of the device A. A service end of the device B can also advertise a WFDS capable of being provided by the service end to an ASP end of the device B. In order for the device B to use a WFDS as a seeker, an application end of the device B indicates a service to be used to the service end and the service end indicates the ASP end to find out a target device to use the WFDS.

In order to find out the target device to use the WFDS, the ASP end of the device B transmits a P2P (peer to peer) probe request message [S910]. In this case, the P2P probe request message includes a service name, which is intended to be found out by the ASP end of the device B or is capable of being supported by the ASP end of the device B, in a service hash form in a manner of hashing the service name. Having received the P2P probe request message from the seeker, if the device A supports the corresponding service, the device A transmits a P2P probe response message to the device B in response to the P2P probe request message [S920]. The P2P probe response message includes a service supported by a service name or a hash value and a corresponding advertise ID value. This procedure corresponds to a device discovery procedure indicating that the device A and the device B are WFDS devices. It is able to know whether a service is supported via the device discovery procedure.

Subsequently, it is able to know a specific service in detail via a P2P service discovery procedure, optionally. The device B, which has found a device capable of performing a WFDS with the device B, transmits a P2P service discovery request message to the device [S930]. Having received the P2P service discovery request message from the device B, the ASP end of the device A transmits a P2P service discovery response message to the device B in a manner of matching the service advertised by the service end of the device A with a P2P service name and a P2P service information received from the device B with each other [S940]. In this case, a GAS protocol defined by IEEE 802.11u is used. As mentioned in the foregoing description, when a request for a service search is completed, the device B can inform an application and a user of a search result. At this point, a group of Wi-Fi Direct is not formed yet. If a user selects a service and the selected service performs a connect session, P2P group formation is performed.

Before the present invention is explained, it is necessary to be cautious of one thing. It is necessary to distinguish a legacy Wi-Fi Direct connection from Wi-Fi Direct service (WFDS) connection described in the present invention. According to the legacy Wi-Fi Direct, it mainly concerns up to a L2 layer, whereas the recently discussed WFDS connection concerns not only the L2 layer but also a higher layer of the L2 layer. In particular, the WFDS connection is dealing with a service session connection performed by an application service platform. Hence, the WFDS connection may have more diversified and more complex cases compared to the legacy L2 layer connection and it is required to have definition on the cases. In addition, in case of connecting Wi-Fi Direct only between devices and in case of connecting Wi-Fi Direct service between devices, configuration and order of a control frame, which is exchanged via Wi-Fi, may become different.

In this case, for example, among the aforementioned interfaces, the BLE may correspond to a Bluetooth transmission/reception scheme in a form of using a frequency of 2.4 GHz and reducing power consumption. In particular, in order to quickly transmit and receive data of extremely small capacity, it may use the BLE to transmit data while reducing power consumption.

And, for example, the NAN (neighbor awareness networking) network may correspond to NAN devices using a set of the same NAN parameters (e.g., a time period between continuous discovery windows, a period of a discovery window, a beacon interval, a NAN channel, etc.). The NAN devices can configure a NAN cluster. In this case, the NAN cluster uses a set of the same NAN parameters and may correspond to a set of NAN devices synchronized with the same window schedule. A NAN device belonging to the NAN cluster can directly transmit a multicast/unicast NAN service discovery frame to a different NAN device within a range of a discovery window.

And, for example, the NFC may operate on a relatively low frequency band such as 13.56 MHz. In this case, if two P2P devices support the NFC, it may optionally use an NFC channel. A seeker P2P device can discover a P2P device using the NFC channel. When an NFC device is discovered, it may indicate that two P2P devices agree on a common channel for forming a group and share provisioning information such as a password of a device.

A method of interworking via an ASP for the aforementioned interfaces is explained in detail in the following. In this case, although the abovementioned configurations are proposed as an interface capable of being interlocked with the ASP, this is an example only. It may support a different interface as well, by which the present invention may be non-limited.

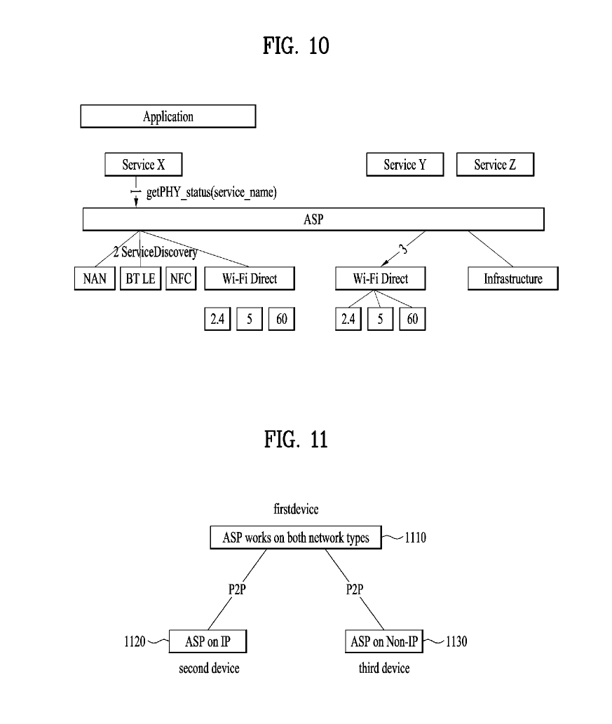

FIG. 10 is a diagram for a service application platform (ASP) supporting a plurality of interfaces.

As mentioned in the foregoing description, a service end of an advertiser device corresponding to a device supporting WFDS advertises a service capable of being provided by the service end and a service end of a seeker device corresponding to a different device supporting the WFDS can indicate an ASP end to search for a target device for which the service is to be used. In particular, it may be able to support the WFDS between devices via the ASP.

In this case, referring to FIG. 10, the ASP can support a plurality of interfaces. In this case, for example, the ASP can support a plurality of interfaces for performing service discovery. And, the ASP can support a plurality of interfaces for performing service connection.

In this case, for example, a plurality of the interfaces for performing the service discovery may correspond to at least one selected from the group consisting of Wi-Fi Direct, NAN (Neighbor Awareness Networking), NFC (Near Field Communication), BLE (Bluetooth Low Energy), and WLAN Infrastructure.

And, a plurality of the interfaces for performing the service connection may correspond to at least one selected from the group consisting of Wi-Pi Direct, P2P, and Infrastructure. And, for example, the ASP can support a plurality of frequency bands. In this case, for example, a plurality of the frequency bands may correspond to 2.4 GHz, 5 GHz, 60 GHz, and the like. And, for example, the ASP can support information on a frequency band less than 1 GHz. In particular, the ASP can support a plurality of frequency band and is not restricted to a specific frequency band.

Referring to FIG. 10, a first device can perform device discovery or service discovery on a first service using the ASP. Subsequently, if searching for the device discovery or the service discovery is completed, it may perform service connection based on a search result. In this case, for example, an interface used for performing the service discovery may be different from an interface used for performing the service connection. The interfaces can be selected from among a plurality of interfaces.

In this case, it may be necessary to define information or a parameter for supporting a plurality of the interfaces in the ASP. In the following, information or a parameter for providing a service using the ASP supporting a plurality of interfaces is described.

Regarding the ASP, for example, a service end of a device can obtain information on a service discovery method capable of supporting a first service and a connection method from the ASP. In this case, the first service may correspond to a service provided by the device and is not restricted to a specific service.

The service end of the device can call AdvertiseService( ) or SeekService( ) method to the ASP based on the information obtained from the ASP. In particular, similar to a legacy ASP operation, the device can use the ASP as an advertiser or a seeker to perform service discovery on the first service. After the service discovery is performed on the first service, the device can perform service connection based on a result of the service discovery. In this case, the service connection may correspond to a P2P or a WLAN infrastructure. In this case, for example, since both the service connections support a plurality of frequency bands, the service connection can be performed on the basis of a preferred band.

More specifically, referring to FIG. 10, the service end of the device can transmit a message for a service to be used by the device to the ASP by calling getPHY_status(service_name) method. In this case, the service end receives a return value from the ASP and may be able to obtain information on a plurality of frequency bands for a service discovery method and a service connection method supported by the ASP. By doing so, the device informs the ASP of information on a preferred connection method for a service and a preferred frequency band for the service and the device can obtain information on a service discovery method and a service connection method supported by the ASP. The ASP performs service discovery based on the information received from the service end, searches for a specific device, and connects the specific device with the ASP to use a service.

In this case, for example, information described in Table 1 can be included in the aforementioned getPHY_status (service_name). In this case, Table 1 includes information on an upper concept at the left of Table 1 and includes information on a lower concept at the right of Table 1.

TABLE 1

| Connectivity | P2P | Multiband | | |
|---|---|---|---|---|
| methods | | information | 2.4, 5, 60 GHz, | |
| | Infrastructure | BSSID, | | |
| | information | Multiband | 2.4, 5, 60 GHz | Channel Index |
| | | information | | per band |

| Service | NAN | | |
|---|---|---|---|
| Discovery | BTLE | | |
| methods | NFC | | |
| | Infrastructure | | |
| | P2P | Multiband | 2.4, 5, 60 GHz, |
| | | information | |

FIG. 11 is a diagram of a method for a device to establish an ASP session based on a different ASP network type using a P2P connection.

As mentioned in the foregoing description, an ASP can perform a device/service discovery using a plurality of interfaces. And, the ASP can perform a connection using a P2P connection or a WLAN infrastructure.

And, for example, an ASP network type can be configured in various ways. In this case, the ASP network type may correspond to an ASP network type supporting an IP (internet protocol) and may operate based on an IP supporting ASP network type (hereinafter, first ASP network type). In this case, for example, a UDP (user datagram protocol) and a TCP (transmission control protocol) can be used for data communication and the like based on an IP. In particular, the first ASP network type may correspond to a network type which is supported to perform data exchange between devices based on an IP.

On the contrary, the ASP network type may correspond to an ASP network type not supporting an IP and may operate based on a non-IP ASP network type (hereinafter, second ASP network type). In this case, for example, a WSB (wireless serial bus) can be used for data communication and the like based on non-IP. In particular, a network type for an ASP can be classified into the first ASP network type and the second ASP network type according to whether or not an IP is supported by the network type.

In this case, for example, referring to FIG. 11, an ASP of a first device 1110 may correspond to a device capable of supporting both a first ASP network type and a second ASP network type. And, for example, the first device 1110 may correspond to a device playing a role of a group owner for a P2P group which is formed based on the aforementioned P2P connection.

And, an ASP of a second device 1120 may correspond to an ASP operating based on the first ASP network type. In this case, for example, the ASP of the second device 1120 may correspond to an ASP having capability capable of operating based on the second ASP network type. In this case, for example, the ASP of the second device 1120 may determine that an ASP network type is configured by the first ASP network type for a P2P connection of the first device 1110 only. And, for example, the ASP of the second device 1120 may determine that an ASP network type is configured by the first ASP network type for a P2P connection of the first device 1110 and a specific service only. In particular, an ASP network type can be restrictively set to a specific connection of a device or a specific service of a device, by which the present invention may be non-limited.

And, an ASP of a third device 1130 may correspond to an ASP operating based on the second ASP network type. In this case, for example, the ASP of the third device 1130 may correspond to an ASP having capability capable of operating based on the first ASP network type and the second ASP network type. In this case, for example, the ASP of the third device 1130 may determine that an ASP network type is configured by the second ASP network type for a P2P connection of the first device 1110 only. And, for example, the ASP of the third device 1130 may determine that an ASP network type is configured by the second ASP network type for a P2P connection of the first device 1110 and a specific service only. In particular, an ASP network type can be restrictively set to a specific connection of a device or a specific service of a device, by which the present invention may be non-limited.

In particular, the ASP of the first device 1110 and the second device 1120 can configure a connection based on the first ASP network type using a P2P connection. And, the ASP of the first device 1110 and the third device 1130 can configure a connection based on the second ASP network type using a P2P connection.

In this case, when the first device 1110 performs a connection with a different device (e.g., the second device or the third device), it is necessary for the first device to provide information on an ASP network type to the different device.

For example, as mentioned in the foregoing description, the first device 1110 may correspond to a group owner. In this case, the first device 1110 may receive a probe request frame and transmit a probe response frame. In this case, the probe response frame can include fields shown in Table 2 in the following.

In this case, a P2P group info field included in the probe response frame can include information on each of client devices. In this case, the aforementioned ASP network type information can be included in the P2P group info field as the information on each of the client devices. For example, referring to FIG. 11, information indicating that the second device 1120 corresponds to the first ASP network type and the third device 1130 corresponds to the second ASP network type can be included in the P2P group info field.

And, the P2P group info field can be configured as Table 3 in the following. In this case, the P2P group info field can include a P2P client info descriptor(s) field. In this case, the P2P client info descriptor(s) field can be configured as Table 4 in the following. In this case, for example, a field indicating the information on the ASP network type can be added to the P2P client info descriptor(s) field as a new field. In particular, a new field belonging to the P2P client info descriptor(s) field can indicate the information on the ASP network type.

And, for example, the ASP network information can be indicated using at least one of the legacy fields included in the P2P client info descriptor(s) field. In particular, it may be able to indicate the ASP network information using the P2P client info descriptor(s) field, by which the present invention may be non-limited.

TABLE 2

| | Attribute | |
|---|---|---|
| Attributes | ID | Note |
| P2P Capability | 2 | The P2P Capability |
| | | attribute shall be |
| | | present in the P2P IE. |
| Extended Listen | 8 | The Extended Listen |
| Timing | | Timing attribute |
| | | may be present |
| | | in the P2P IE |
| Notice of Absence | 12 | The Notice of Absence |
| | | attribute shall only be |
| | | present in the P2P IE |
| | | in the Probe Response |
| | | frames transmitted by a |
| | | P2P Group Owner when a |
| | | Notice of Absence schedule |
| | | (see §3.3.3.2) or non-zero |
| | | CTWindow (see §3.3.2) |
| | | is being advertised in |
| | | the Beacon frames |
| | | (see §3.3.3.2). |
| P2P Device Info. | 13 | The P2P Device Info |
| | | attribute shall be present |
| | | in the P2P 1E to |
| | | indicate the P2P |
| | | Device information. |
| P2P Group Info. | 14 | The P2P Group Info |
| | | attribute shall only |
| | | be present in the P2P |
| | | IE in the Probe |
| | | Response frame |
| | | hat is transmitted by |
| | | a P2P Group Owner. |
| | | The P2P Group |
| | | Info attribute shall be |
| | | omitted if there are zero |
| | | connected P2P Clients. |

TABLE 3

| Field Name | Size (octets) | Value | Description |
|---|---|---|---|
| Attribute | 1 | 14 | Identifying the type |
| ID | | | of P2P attribute. |
| | | | The specific value is |
| | | | defined in Table 6. |
| Length | 2 | variable | Length of the following |
| | | | fields in the attribute. |
| P2P | Sum of all P2P | | List of P2P Client Info |
| Client | Client Info | | Descriptor(s) for P2P Devices |
| Info | Descriptor(s) | | associated with this P2P |
| Descriptor(s) | | | Group Owner (see Table 31) |

TABLE 4

| | Size | | |
|---|---|---|---|
| Field Name | (octets) | Value | Description |
| Length | 1 | variable | Length of the following fields. |
| P2P Device | 6 | — | An identifier used to |
| address | | | uniquely reference |
| | | | a P2P Device |
| P2P | 6 | — | An address used to identify |
| Interface | | | a P2P Device within a |
| address | | | P2P Group. |
| Device | 1 | variable | A set of parameters |
| Capability | | | indicating P2P Device's |
| Bitmap | | | capabilities, as defined |
| | | | in Table 12 |
| Config | 2 | As defined | The WSC Methods that are |
| Methods | | in [2] | supported by this device e.g. |
| | | | PIN from a Keypad, PBC |
| | | | etc. Contains only the Data |
| | | | part of the WSC Config |
| | | | Methods attribute (see [2]). |
| | | | Note-Byte ordering within |
| | | | the Config Methods field |
| | | | shall be big-endian. |
| Primary | 8 | As | Primary Device Type of |
| Device | | defined | the P2P Client (see Annex B). |
| Type | | in | Contains only the Data part |
| | | Annex B | of the WSC Primary Device |
| | | | Type attribute (excludes |
| | | | the Attribute ID and Length |
| | | | fields). Note-Byte ordering |
| | | | within the Primary Device |
| | | | Type field shall be big-endian. |
| Number of | 1 | variable | Indicating number of Secondary |
| Secondary | | | Device Types in the Secondary |
| Device Types | | | Device Type List field. This |
| | | | field set to 0 indicates no |
| | | | Secondary Device Type List. |
| Secondary | variable | 8*n | List of Secondary Device Types |
| Device | | | of the P2P Client (see [2]). This |
| Type List | | | field is optional. This field is |
| | | | present only if the Number of |
| | | | Secondary Device Types field is |
| | | | not 0 and contains only the Data |
| | | | part of the WSC Secondary Device |
| | | | Type List attribute (excludes the |
| | | | Attribute ID and Length fields), |
| | | | Note Byte ordering within the |
| | | | Secondary Device Type List |
| | | | field shall be big-endian., |
| Device | variable | As | Friendly name of the P2P Client. |
| Name | | defined | Contains the entire WSC Device |
| | | in [2] | Name attribute in TLV format |
| | | | (see [2]) |
| | | | Note-Byte ordering within |
| | | | the Device Name field |
| | | | shall be big-endian. |

And, for example, the first device 1110 firstly forms a P2P group with a different device (second device or third device) and may be then able to negotiate an ASP network type using an IP in a provision discovery (PD) request procedure. The first device 1110 performs a procedure of forming a P2P group with a different device and may be then able to negotiate an ASP network type between a first ASP network type based on an IP and a second ASP network type not supporting an IP in a procedure of exchanging a PD request frame and a PD response frame. In particular, an ASP network type can be determined in a PD request procedure.

As a different example, a P2P group can already be formed by the first device 1110. In this case, for example, when a different device joins the previously formed P2P group and transmits a PD request frame, if ASP network type information is added to feature capability and the information is exchanged between devices, an ASP network type can be determined, by which the present invention may be non-limited.

As a further different example, it may be able to use service network type information based on whether a service operates based on an IP. In particular, when a device provides a specific service, it may be able to differently support a network type according to a service. In this case, for example, it may be able to define a service network type supporting an IP (hereinafter, a first service network type) and a service network type not supporting an IP (hereinafter, a second service network type).

In this case, for example, the first device 1110 can provide a service to the second device 1120 based on the first service network type for a service. And, the first device 1110 can provide a service to the third device 1130 based on the second service network type for the same service. In particular, a network type can be defined according to a service, by which the present invention may be non-limited.

And, for example, as mentioned in the foregoing description, an ASP can perform a service discovery via a plurality of interfaces. In this case, for example, the ASP network type information and/or the service network type information can be provided via a plurality of the interfaces. In this case, for example, a parameter for the ASP network type information and/or the service network type information can be added to AdvertiseService( )/SeekService( ) method as a method used by the ASP. And, for example, a parameter for the ASP network type information and/or the service network type information can be added to NAN Publish( )/Subscribe( ) method as a NAN discovery engine. And, for example, a parameter for the ASP network type information and/or the service network type information can also be added to BLE service discovery and NFC, by which the present invention may be non-limited.

And, for example, the ASP network type information and/or the service network type information can also be added as a P2P IE (information element). In this case, a new attribute field can be added as the P2P IE or the aforementioned information can be included in a previously defined attribute field, by which the present invention may be non-limited.

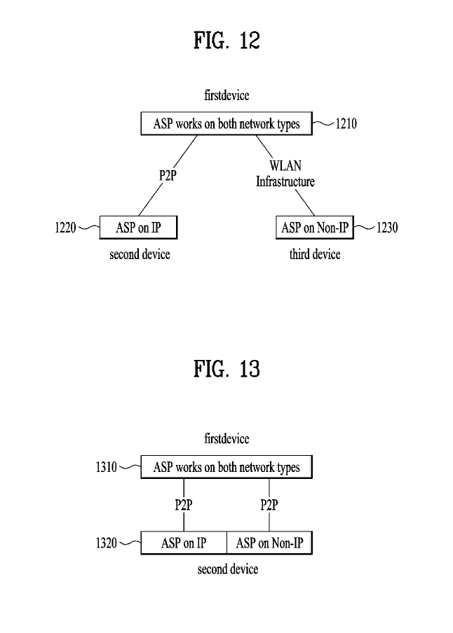

FIG. 12 is a diagram of a method for a device to connect ASP network types different from each other using a different connection method.

In this case, a first device 1210 and a second device 1220 can perform a connection based on a P2P connection and a first ASP network type. And, the first device 1210 and a third device 1230 can perform a connection based on a WLAN infrastructure connection and a second ASP network type. In this case, the aforementioned configuration may correspond to an embodiment. In particular, when the first device 1210 performs a connection with a different device, a connection method and an ASP network type can be differently configured according to a device, by which the present invention may be non-limited.

In this case, for example, a device informs an ASP of a preferred connection method for a service and information on a preferred frequency band and can obtain information on a service discovery method and a service connection method supported by the ASP. In this case, when the device obtains the information on the service connection method, the device can provide the ASP network type information and/or the service network type information as well. In particular, when the first device 1210 and a different device (second device or third device) perform a service discovery on a service and perform a service connection, the first device can provide the ASP network type information and/or the service network type information as well in a procedure of providing information on a service connection method, by which the present invention may be non-limited.

As a different example, when the first device 1210 and the second device 1220 use a specific service, the first device 1220 can perform a service discovery on a different service with a different device. In this case, for example, the first device 1220 can inform different devices of information on the second device 1220 by including the information in the service discovery. In particular, information on a device, which is using a specific service in a manner of being connected with the first device 1220, can be provided in the service discovery procedure.

And, for example, the third device 1230 can be connected with the first device 1210 via WLAN infrastructure. In this case, for example, if the third device 1230 is switched to a P2P connection, it is necessary to perform seamless handover. In this case, for example, the third device 1230 may be able to switch to the P2P connection by joining a P2P group previously formed in the first device 1210 or may generate a new P2P group with the first device 1210.

As a different example, the second device 1220 can be connected with the first device 1220 via P2P. In this case, for example, if the second device 1220 changes a connection to WLAN infrastructure, it is necessary to perform seamless handover. In this case, for example, the second device 1220 can perform the change by checking whether or not the second device 1220 and the first device 1210 are connected to the same BSSID. As a further different example, if it is determined that one of the first device 1210 and the second device 1220 is connected and the other one is capable of being connected, it may be able to wait for prescribed time as time for the device capable of being connected to perform a connection. In this case, for example, if a not connected device completes a connection, the device informs a counterpart device of a connection completion message and may be able to perform a connection change via the WLAN infrastructure.

FIG. 13 is a diagram of a method for a device to connect a different device using a P2P connection method and connect a different service using a different ASP network type.

A first device 1310 and a second device 1320 can perform a connection using a P2P connection method. In this case, for example, the first device 1310 and the second device 1320 can perform the connection using a WLAN infrastructure connection method. In particular, the first device 1310 and the second device 1320 can perform the connection, by which the present invention may be non-limited. In this case, for example, the first device 1310 and the second device 1320 may set a different ASP network type to a different service. In particular, the first device 1310 and the second device 1320 are connected based on the same connection method and may set a different ASP network type according to a service. And, for example, the first device 1310 and the second device 1320 may set a different service network type to a different service. In particular, the first device 1310 and the second device 1320 may set a different ASP network type and/or service network type to a different service, by which the present invention may be non-limited. Yet, in the following description, a case that the first device 1310 and the second device 1320 set a different ASP network type to a different service is described as a reference. Yet, in the following description, when a service network type is differently configured according to a service, the identical principle can be applied.

In this case, for example, referring to FIG. 13, the first device 1310 and the second device 1320 can perform a connection. In this case, the connection can be performed via a P2P connection or a WLAN infrastructure connection, by which the present invention may be non-limited. For example, the first device 1310 and the second device 1320 can perform the connection via the P2P connection.

For example, first of all, the first device 1310 and the second device 1320 perform a connection based on a first ASP network type for a first service and establish an ASP session. Subsequently, the first device 1310 and the second device 1320 may intend to perform a connection based on a second ASP network type for a second service.

In this case, for example, if a service discovery for the second service is completed, the first device 1310 and the second device 1320 can use the previously established ASP session.

In this case, it is necessary for the first device 1310 and the second device 1320 to check ASP network type information on the second service of which the service discovery is completed. In particular, since it is able to configure a different ASP network type for the first device 1310 and the second device 1320 in a different service, it is necessary for the first device 1310 and the second device 1320 to have a procedure for checking the ASP network type. In this case, for example, the first device 1310 and the second terminal 1320 can exchange feature capability information on the second service based on an ASP coordination protocol (ASP CP). In this case, the feature capability information can include ASP network type information on the second service. For example, a message for the feature capability information can be defined based on an ASP CP message format.

More specifically, Table 5 in the following may correspond to an ASP CP general message format. In this case, for example, an Opcode field of the ASP CP general message format can define a FEATURE_CAPA_EXCHANGE field using one of the bits reserved for the ASP network type information. This is shown in Table 6 in the following. In particular, other bits are configured in a manner of being similar to a legacy system for backward compatibility with the legacy system and the FEATURE_CAPA_EXCHANGE field can be defined using a bit among the reserved bits to indicate the ASP network type information.

TABLE 5

| | Size | | |
|---|---|---|---|
| Field | (octets) | Value | Description |
| Opcode | 1 | See Table 2 | Opcode for each |
| | | | message type is |
| | | | listed in Table 2 |
| Sequence | 1 | | Sequence Number is |
| Number | | | incremented by 1 when |
| | | | the device sends each |
| | | | new message |
| Payload | variable | | Each message type |
| | | | defines a payload |
| | | | format |

TABLE 6

| Opcode | Message |
|---|---|
| 0 | REQUEST_SESSION |
| 1 | ADDED_SESSION |
| 2 | REJECTED_SESSION |
| 3 | RMOVE_SESSION |
| 4 | ALLOWED_PORT |
| 5 | VERSION |
| 6 | DEFERRED_SESSION |
| xx | FEATURE CAPA EXCHANGE |
| 8-253 | Reserved |
| 254 | ACK |
| 255 | NACK |

And, a message format for exchanging the feature capability information is shown in Table 7 in the following. In particular, a field in which information respectively corresponding to a requester and a responder is included can be defined in a payload of a message for exchanging the feature capability information. In this case, for example, a message for a requester can include a feature description field for the requester. In this case, the feature description requester field can be transmitted while including information on an ASP network type capable of being supported by a requester device.

And, for example, a message for a responder can include a valid feature capability field for the responder. In this case, the valid feature capability field can be transmitted while including information on an ASP network type capable of being used by a responder device.

TABLE 7

| | Size | | |
|---|---|---|---|
| Field | (octets) | Value | Description |
| Opcode | 1 | 0xXX | Opcode is defined |
| | | | in Table 2. |
| Sequence | 1 | variable | The Sequence Number |
| Number | | | is assigned at |
| | | | transmission time. |
| Requester: | 1 | 0x01: UDP | The Requestor only |
| Feature | | Transport | use this field. |
| Description | | 0x02: MAC | Otherwise, this field |
| | | 0x03: TCP | is empty |
| | | Transport | Both ASPs involved |
| | | 0x04-0x80: | in this PD exchange |
| | | Reserved for | shall use the transport |
| | | future transports | indicated in the PD |
| | | | response for all ASP |
| | | | coordination protocol |
| | | | messaging between the |
| | | | two ASPs. |
| Responder: | 1 | 0x01: UDP | The Responder only use this |
| Valid | | Transport | field. Otherwise, this field |
| Feature | | And/or | is empty |
| Capability | | 0x02: MAC | Both ASPs involved in this |
| | | And/or | PD exchange shall use the |
| | | 0x03: TCP | transport indicated in the |
| | | Transport | PD response for all ASP |
| | | And/or | coordination protocol |
| | | 0x04-0x80: | messaging between the |
| | | Reserved | two ASPs. |
| | | for future | |
| | | transports | |
| | | The PD | |
| | | response | |
| | | for this field | |
| | | has a single | |
| | | transport | |
| | | bit set to 1, | |
| | | indicating | |
| | | a transport that | |
| | | is supported by | |
| | | both the PD | |
| | | Requester and | |
| | | PD Responder. | |

And, for example, if a service discovery is not performed on the second service or it fails to perform the service discovery on the second service, the aforementioned procedure can be performed after the service discovery is performed. In particular, since it is unable to know Session_Info and/or Advertisement_ID information on the second service, the first device 1310 and the second device 1320 perform the service discovery procedure and may be then able to exchange information on the ASP network type. In this case, for example, since the first device 1310 and the second device 1320 have performed a P2P connection based on a first ASP network type, the first device 1310 and the second device 1320 may be in an IP connected state. In this case, for example, the first device 1310 and the second device 1320 can perform a service discovery on the second service using such a service discovery method previously used in a legacy IP connected state as UPnP service discovery, bonjour, mDNS, etc. as a different service discovery method.

And, for example, while the first device 1310 and the second device 1320 use an ASP CP, the first device 1310 and the second device 1320 can perform a service discovery using a previously established ASP session by defining a SERVICE_DISCOVERY_REQUEST message format and a SERVICE_DISCOVERY_RESPONSE message format. In this case, Tables 8 and 9 in the following show the SERVICE_DISCOVERY_REQUEST message format and the SERVICE_DISCOVERY_RESPONSE message format.

Subsequently, as mentioned in the foregoing description, the aforementioned feature capability negotiation procedure can be separately performed to establish an ASP session for the second service.

TABLE 8

| | Size | | |
|---|---|---|---|
| Field | (octets) | Value | Description |
| Opcode | 1 | 0xXX | Opcode is defined |
| | | | in Table 2 |
| Sequence | 1 | variable | The Sequence |
| Number | | | Number is |
| | | | assigned at |
| | | | transmission |
| | | | time. |
| Service_name | 6 | variable | |
| Mac_address | 6 | variable | |
| Service specific | 1 | | |
| information | | | |
| request | | | |

TABLE 9

| | Size | | |
|---|---|---|---|
| Field | (octets) | Value | Description |
| Opcode | 1 | 0xXX | Opcode is defined |
| | | | in Table 2 |
| SequenceNumber | 1 | variable | The Sequence |
| | | | Number is assigned |
| | | | at transmission |
| | | | time. |
| Adversiement_id | 4 | Variable | |
| Service_name | 6 | variable | |
| Service specfic_ | 1 | Variable | |
| information_length | (0-144) | | |
| Service specific | Variable | variable | |
| information | (0-144) | | |
| Service status | 1 | | |

As a different example, the first device 1310 and the second device 1320 can perform an ASP session connection on the second service in a state that the first device 1310 and the second device 1320 have performed a connection on the first service based on the second ASP network type. In the foregoing description, although a state that the first device 1310 and the second device 1320 has performed a connection on the first service based on the first ASP network type is mainly described, the same principle can also be applied to a state that the first device 1310 and the second device 1320 perform a connection based on the second ASP network type. In particular, the first device 1310 and the second device 1320 define a message format for ASP network type information based on a previously established ASP session and exchange the message format to determine an ASP network type for the second service, by which the present invention may be non-limited.

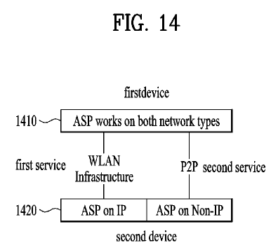

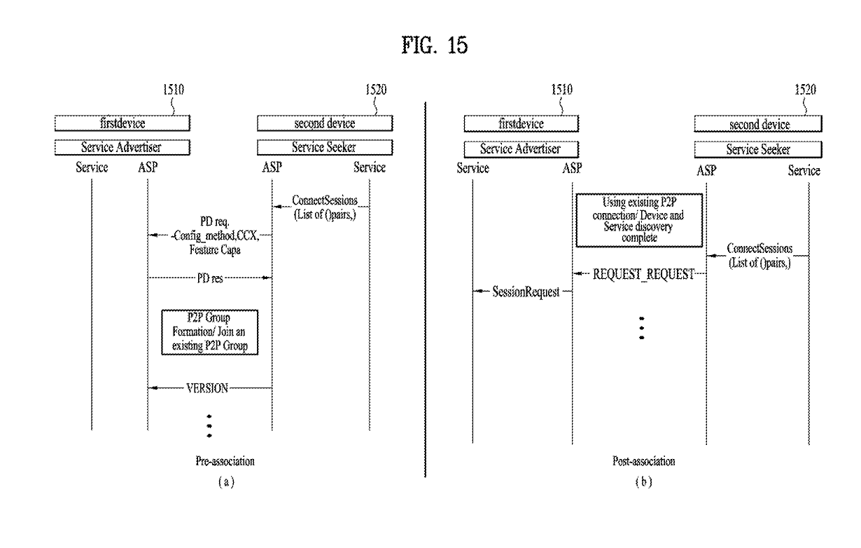

FIG. 14 is a diagram of a method for a device to connect a different device using a different connection method and a different ASP network type for a different service.

A first device 1410 and a second device 1420 can use a different connection method for a different service. And, the first device 1410 and the second device 1420 can configure a different ASP network type for a different service.

In this case, for example, referring to FIG. 14, the first device 1410 and the second device 1420 are connected via a WLAN infrastructure connection method for a first service and a connection can be established based on a first ASP network type. And, the first device 1410 and the second device 1420 are connected via a P2P connection method for a second service and a connection can be established based on a second ASP network type. Yet, the abovementioned configuration is just an embodiment only. A different connection method and a different ASP network type can be configured for a different service.

In this case, for example, the first device 1410 and the second device 1420 may use a WLAN infrastructure as a device/service discovery method. In this case, for example, the first device 1410 and the second device 1420 may support both the WLAN infrastructure and the P2P connection as a connection method according to search result( ). And, the first device 1410 and the second device 1420 may by in a state of being connected with the same BSSID.

In this case, for example, the first device 1410 and the second device 1420 may perform a P2P connection procedure on a second service and use a service. In this case, the first device 1410 and the second device 1420 may perform a service discovery on a first service. In this case, if the first device 1410 and the second device 1420 use the WLAN infrastructure connection for the first service, the first device 1410 and the second device 1420 may be able to establish an ASP session for the first service in a state that the WLAN infrastructure connection is performed via the aforementioned feature capability exchange procedure. In particular, the first device 1410 and the second device 1420 obtains ASP network type information on the first service via the feature capability exchange procedure and may be able to perform an ASP session connection. In this case, a message used for the feature capability exchange procedure is identical to the message mentioned earlier in FIG. 13 and may operate as an ASP CP which is connected via P2P.

Unlikely, the first device 1410 and the second device 1420 may perform WLAN infrastructure connection on the first service and use a service. In this case, the first device 1410 and the second device 1420 may perform a service discovery on the second service based on the WLAN infrastructure. In this case, for example, the first device 1410 and the second device 1420 can perform the service discovery on the basis of an IP based on the first ASP network type. And, for example, although the first device 1410 and the second device 1420 are connected based on the first ASP network type, the first device 1410 and the second device 1420 can perform a service discovery based on a P2P using the aforementioned ASP CP message format. Subsequently, the first device 1410 and the second device 1420 can perform an ASP session connection by exchanging a PD request/response. In particular, the first device 1410 and the second device 1420 not only perform a service discovery based on an IP but also perform a service discovery on the second service on the basis of a connected ASP session based on the ASP CP message to perform the ASP session connection.

And, for example, the first device 1410 and the second device 1420 may use P2P as a device/service discovery method. In this case, for example, the first device 1410 and the second device 1420 can support both the WLAN infrastructure and the P2P connection as a connection method according to search result( ). And, the first device 1410 and the second device 1420 may by in a state of being connected with the same BSSID.

In this case, for example, the first device 1410 and the second device 1420 may perform a P2P connection procedure on a second service and use a service. In this case, the first device 1410 and the second device 1420 may perform a service discovery on a first service. In this case, if the first device 1410 and the second device 1420 use the WLAN infrastructure connection for the first service, the first device 1410 and the second device 1420 may be able to establish an ASP session for the first service in a state that the WLAN infrastructure connection is performed via the aforementioned feature capability exchange procedure. In particular, the first device 1410 and the second device 1420 obtains ASP network type information on the first service via the feature capability exchange procedure and may be able to perform an ASP session connection. In this case, a message used for the feature capability exchange procedure is identical to the message mentioned earlier in FIG. 13 and may operate as an ASP CP which is connected via P2P.

Unlikely, the first device 1410 and the second device 1420 may perform WLAN infrastructure connection on the first service and use a service.

In this case, the first device 1410 and the second device 1420 may perform a service discovery on the second service based on the WLAN infrastructure. In this case, for example, the first device 1410 and the second device 1420 can perform the service discovery on the basis of an IP based on the first ASP network type. And, for example, although the first device 1410 and the second device 1420 are connected based on the first ASP network type, the first device 1410 and the second device 1420 can perform a service discovery based on a P2P using the aforementioned ASP CP message format. Subsequently, the first device 1410 and the second device 1420 can perform an ASP session connection by exchanging a PD request/response. In particular, the first device 1410 and the second device 1420 not only perform a service discovery based on an IP but also perform a service discovery on the second service on the basis of a connected ASP session based on the ASP CP message to perform the ASP session connection.

And, for example, when the ASP session connection is performed on the second service, an authentication procedure and an association procedure can be omitted, by which the present invention may be non-limited.

FIG. 15 is a diagram for a method of establishing an ASP session.

FIG. 15 (a) is a diagram for a method of establishing an ASP session before a first device 1510 is associated with a second device 1520. In this case, for example, the first device 1510 and the second device 1520 may correspond to an advertiser device and a seeker device, respectively. In this case, for example, a service end of the second device 1520 can call connectsessions( ) method. In this case, an ASP of the second device 1520 can transmit a PD request frame to the first device 1510. In this case, the PD request frame can include configuration information, CCX, information on feature capability, and the like. The first device 1510 can transmit a PD response frame to the second device 1520 in response to the PD request frame. Subsequently, the first device 1510 and the second device 1520 may form a new P2P group or join a previously formed P2P group. By doing so, the first device 1510 and the second device 1520 can perform an ASP session connection.

On the contrary, FIG. 15 (b) shows a case that the first device 1510 and the second device 1520 have already formed association. In particular, the first device 1510 and the second device 1520 may be in a state that an ASP session connection has already been performed. In this case, for example, a service end of the second device 1520 can call connectSessions method. In this case, an ASP of the second device 1520 can transmit a request session message to the first device 1510 based on a previously established ASP session. In this case, an ASP of the first device 1510 can call sessionRequest( ) to a service end of the first device 1510. In this case, a request session message may have a message format based on Table 8. In particular, the first device 1510 and the second device 1520 can establish an ASP session for a different service using a previously established ASP session.

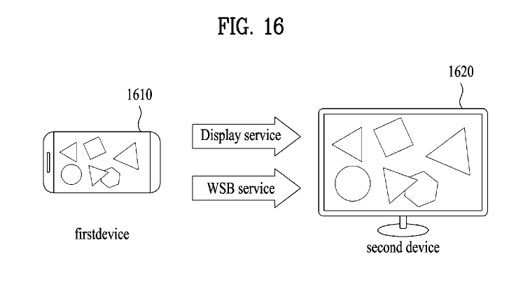

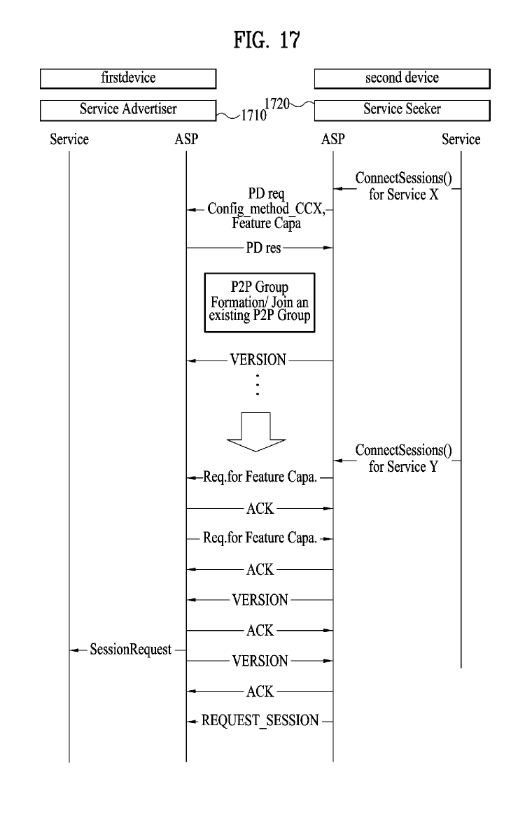

FIGS. 16 and 17 are diagrams for a method of establishing an ASP session when a different network type is set to a different service.

As mentioned in the foregoing description, two devices may operate based on a different ASP network type for a different service. In this case, for example, referring to FIG. 16, a first device 1610 can perform a display service with a second device 1620. In this case, the display service may correspond to a service which is provided based on a first ASP network type. In particular, the display service may correspond to a service which is provided based on an IP. In this case, for example, the first device 1610 may intend to perform a WSB service with the second device 1620. In this case, the WSB service may correspond to a service which is provided based on a second ASP network type. In particular, the WSB service may correspond to a service which is provided based on a non-IP.

In this case, for example, referring to FIG. 17, a first device 1710 and a second device 1720 may be able to establish an ASP session based on a first service. In this case, for example, the first service can be configured by a first ASP network type. In this case, the first service may correspond to the aforementioned display service.

In this case, the first device 1710 and the second device 1720 may intend to provide a second service. In this case, for example, an ASP network type of the second service can be configured by a first ASP network type or a second ASP network type. Hence, when the first device 1710 and the second device 1720 provides the second service, it may be able to check whether or not each of the devices is supported based on the ASP network type of the second service and it may be necessary to perform negotiation to determine a type to be used.

In this case, for example, the first device 1710 and the second device 1720 can perform a feature capability information exchange procedure on the second service based on an ASP CP to check information on the ASP network type.

More specifically, the second device 1720 can transmit a feature capability request message to the first device 1710. In this case, the feature capability request message can include ASP network type information capable of being supported by the second device 1720. In particular, the feature capability request message can include ASP network type information capable of being supported by the second device 1720 for the second service. For example, a message for feature capability information can be defined based on an ASP CP message format mentioned earlier in Tables 5 to 7.

Subsequently, the first device 1710 can transmit a feature capability response message to the second device 1720. In this case, the feature capability response message can include ASP network type information to be used for the second service based on the ASP network type information supported by the second device 1720. In this case, for example, if the second service corresponds to the aforementioned WSB service, which is configured based on the second ASP network type, the feature capability response message can include information indicating the second ASP network type. For example, a message for feature capability information can be defined based on an ASP CP message format mentioned earlier in Tables 5 to 7.

In particular, the first device 1710 and the second device 1720 can perform a feature capability exchange procedure to exchange the ASP network type information on the second service based on a previously established ASP session. By doing so, the first device 1710 and the second device 1720 are able to check ASP network type information on a new service. Or, the first device 1710 and the second device 1720 are able to check service network type information on a new service.

And, for example, it may be able to perform the same function by adding a field to a previously defined message instead of defining a new message for feature capability

For example, a seeker device (second device) may be aware of network type information of an ASP CP in advance for a corresponding service. Hence, when the seeker device transmits a VERSION message or a REQUEST SESSION message based on the network type information, it may be able to make a negotiation procedure for feature capability or a confirmation procedure to be performed.

For example, a field for the feature capability can be added to the VERSION message. And, for example, a field for the feature capability can be added to the REQUEST SESSION message. The fields are shown in Tables 10 and 11 in the following. In this case, Table 10 shows fields for the VERSION message and Table 11 shows fields for the REQUEST SESSION message.

In particular, the first device 1710 and the second device 1720 do not perform an additional message exchange procedure necessary for obtaining the ASP network type information on the second service. Instead, the first device 1710 and the second device 1720 define a new field to a previously performed procedure to perform negotiation and confirmation. By doing so, it may be able to prevent delay due to the additional procedure.

And, for example, as defined in the related art, if a device wants to establish an ASP session, the device represents ASP network type capability for a corresponding service in a bitmask form and transmits the ASP network type capability.

In this case, if a device receiving a request for an ASP session receives the message, the device compares the received ASP network type capability with ASP network type capability (UDP and/or non-IP) supported by a service of the device, selects one, and transmits the selected ASP network type capability. And, for example, if the ASP network type capabilities are do not match with each other, the device may make a response for the reason of the mismatch.

TABLE 10

| | Size | | |
|---|---|---|---|
| Field | (octets) | Value | Description |
| Opcode | 1 | 0xXX | Opcode is defined |
| | | | in Table 2 |
| Sequence | 1 | variable | The Sequence |
| Number | | | Number is assigned |
| | | | at transmission time. |
| coordination_ | 1 | variable | Coordination |
| version | | | protocol version |
| | | | number. |
| vendor_ | | variable | This contains |
| information_ | | (0 − 0xFF) | the length of the |
| length | | | vendor_information |
| | | | field (number |
| | | | of octets). |
| vendor_ | variable | variable | Vendor-specific |
| information | | | information |
| Requester: | 1 | 0x01: UDP | The Requestor only |
| Feature | | Transport | use this field. |
| Description | | 0x02: MAC | Otherwise, this |
| | | 0x03: TCP | field is empty. |
| | | Transport | Both ASPs |
| | | 0x04-0x80: | involved in this |
| | | Reserved | PD exchange shall |
| | | for future | use the transport |
| | | transport | indicated in the |
| | | | PD response for |
| | | | all ASP coordination |
| | | | protocol messaging |
| | | | between the two |
| | | | ASPs. |
| Responder: | 1 | 0x01: UDP | The Responder only |
| Valid | | Transport | use this field. |
| Feature | | And/or | Otherwise, this |
| Capability | | 0x02: MAC | field is empty. |
| | | And/or | Both ASPs involved |
| | | 0x03: TCP | in this PD exchange |
| | | Transport | shall use the transport |
| | | And/or | indicated in the PD |
| | | 0x04-0x80: | response for all ASP |
| | | Reserved for | coordination protocol |
| | | future | messaging between |
| | | transports. | the two ASPs. |

TABLE 11

| | Size | | |
|---|---|---|---|
| Field | (octets) | Value | Description |
| Opcode | 1 | 0xXX | Opcode is defined |
| | | | in Table 2. |
| Sequence | 1 | variable | The Sequence Number |
| Number | | | is assigned at |
| | | | transmission time. |
| session_id | 6 | variable | The MAC address is |
| | | | used in combination |
| | | | with the session_id to |
| | | | uniquely identify an |
| | | | ASP session. |
| advertisement_ | 4 | variable | This identifier is used in |
| id | | | combination with the |
| | | | session_mac value to |
| | | | uniquely identify |
| | | | an ASP session. |
| | | | This identifier is |
| | | | assigned by the ASP |
| | | | this sending message. |
| session_ | 4 | variable | This is the length |
| information_ | | (0-144) | of the session_information |
| length | | | field (number of octets). |
| session_ | variable | variable | This is the session |
| information | (0-144) | | information data, |
| | | | if received from the |
| | | | ConnectSessions method. |
| Requester: | 1 | 0x01: UDP | The Requestor only |
| Feature | | Transport. | use this field. |
| Description | | 0x02: MAC | Otherwise, this field |
| | | 0x03: TCP | is empty |
| | | Transport | Both ASPs involved |
| | | 0x04-0x80: | in this PD exchange |
| | | Reserved for | shall use the transport |
| | | for future | indicated in the PD |
| | | transports | response for all ASP |
| | | | coordination protocol |
| | | | messaging between |
| | | | the two ASPs. |
| Responder: | 1 | 0x01: | The Responder only use |
| Valid | | UDP | this field. Otherwise, |
| Feature | | Transport | this field is empty |
| Capability | | And/or | Both ASPs involved in |
| | | 0x02: | this PD exchange |
| | | MAC | shall use the transport |
| | | And/or | indicated in the PD |
| | | 0x03: | response for all ASP |
| | | TCP | coordination protocol |
| | | Transport | messaging between |
| | | And/or | the two ASPs. |
| | | 0x04-0x80: | |
| | | Reserved | |
| | | for future | |
| | | transports. | |
| | | The PD | |
| | | response | |
| | | for this | |
| | | field has | |
| | | a single | |
| | | transport | |
| | | bit set to 1, | |
| | | that is | |
| | | supported by | |
| | | both the PD | |
| | | Requester | |
| | | and PD | |
| | | Responder. | |

And, for example, as mentioned in the foregoing description, an ASP network type can be classified into a first ASP network type supporting an IP and a second ASP network type not supporting an IP (non-IP).

Yet, for example, an ASP network type may operate as one of combinations of non-IP, IPv4, and IPv6, or a plurality of combinations. For example, both the IPv4 and the IPv6 can be regarded as the first ASP network type and the non-IP can be regarded as the second ASP network type.

And, for example, the IPv4 is regarded as the first ASP network type, the IPv6 is regarded as the second ASP network type, and the non-IP can be regarded as a third ASP network type. In particular, an ASP network type may operate as one of combinations of non-IP, IPv4, and IPv6, or a plurality of combinations, by which the present invention may be non-limited.

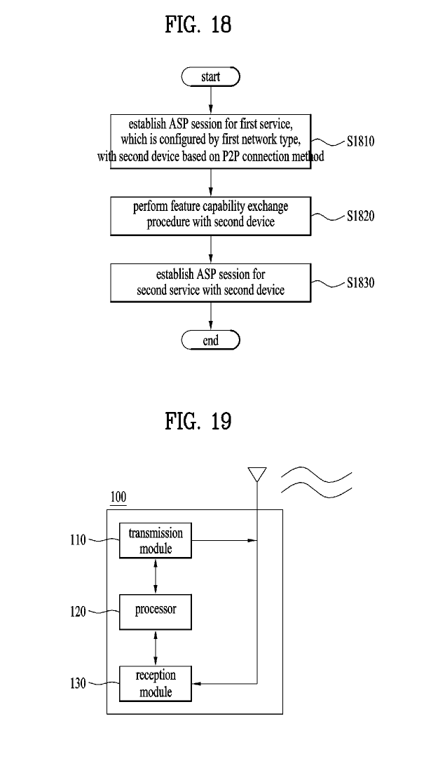

FIG. 18 is a flowchart of a method for a device to support a service using an application service platform according to one embodiment of the present specification.

A first device can establish an ASP session for a first service, which is configured by a first network type, with a second device based on a P2P connection method [S1810]. In this case, as mentioned earlier in FIGS. 10 to 17, the first network type may correspond to one of the first ASP network type and the second ASP network type. In particular, the first network type may correspond to information identified according to whether or not an IP is supported.

Subsequently, the first device and the second device can perform a specific capability exchange procedure [S1820]. In this case, as mentioned earlier in FIGS. 10 to 17, the specific capability exchange procedure may correspond to a feature capability exchange procedure. In this case, the specific capability exchange procedure may correspond to a procedure that the first device transmits a specific capability request message to the second device and receives a specific capability response message from the second device. In this case, the specific capability request message can include information on a network type capable of being supported by the first device. And, the specific capability response message can include information on a network type to be used by the second device. In this case, for example, the specific capability request message and the specific capability response message may correspond to messages based on the aforementioned ASP CP message format. In this case, for example, the specific capability request message and the specific capability response message may correspond to messages configured based on the aforementioned Tables 5 to 7.

In particular, the first device can perform an ASP session connection on a second service using an ASP session previously established for the first service. In this case, since it is able to configure a network type for the first in a manner of being different from a network type for the second service, it is necessary for the first device to provide information on a network type to the second device. To this end, the aforementioned specific capability exchange procedure can be performed.

Subsequently, the first device and the second device can establish an ASP session for the second service [S1830]. In this case, as mentioned earlier in FIGS. 10 to 17, the network type for the second service can be identical to the network type for the first service. And, the network type for the second service may be different from the network type for the first service. In particular, the first device and the second device can perform information exchange via the aforementioned procedures in consideration of environment in which a different network type is configured for a service.

FIG. 19 is a block diagram for a device according to one embodiment of the present specification.

A device may correspond to a device supporting an ASP capable of using a plurality of interfaces. In this case, the ASP of the device can be configured by a different ASP network type according to whether or not the ASP operates based on an IP. In this case, the device can support all different ASP network types. And, for example, the device can support a specific ASP network type only, by which the present invention may be non-limited. In particular, the device may correspond to a device operating based on a different ASP network type. In this case, the device 100 can include a transmission module 110 configured to transmit a radio signal, a reception module 130 configured to receive a radio signal, and a processor 120 configured to control the transmission module 110 and the reception module 130. In this case, the device 100 can perform communication with an external device using the transmission module 110 and the reception module 130. In this case, the external device may correspond to a different device. For example, the external device may correspond to a different device connected via P2P or an AP or a non-AP connected via WLAN infrastructure. As a different example, the external device may correspond to a base station. In particular, the external device may correspond to a device capable of performing communication with the device 100, by which the present invention may be non-limited. The device 100 can transmit and receive digital data such as contents using the transmission module 110 and the reception module 130.

And, for example, as mentioned in the foregoing description, the device may play a role of a seeker device. And, the device may play a role of an advertiser device. In this case, according to one embodiment of the present specification, the processor 120 of the device 100 and a different device can establish an ASP session for a first service, which is configured by a first network type, based on a P2P connection method. In this case, as mentioned in the foregoing description, the first network type may correspond to one of a first ASP network type based on an IP and a second ASP network type not supporting an IR And, the processor 120 of the device 100 can perform a specific capability exchange procedure with a different device. In this case, for example, the device 100 can perform the specific capability exchange procedure using the transmission module 110 and the reception module 130. And, the processor 120 of the device 100 and a different device can establish an ASP session for a second service. In this case, if the device transmits a specific capability (feature capability) request message to the different device and receives a specific capability response message based on the ASP session established for the first service, the aforementioned specific capability exchange procedure can be completed. In this case, the specific capability request message and the specific capability response message can include network type information on the second service. In particular, the processor 120 of the device 100 can establish a new ASP session for a different service using the previously established ASP session. In this case, as mentioned in the foregoing description, the device may perform a procedure for checking a network type for the different service.

The embodiments of the present invention may be achieved by various means, for example, hardware, firmware, software, or a combination thereof.

In a hardware configuration, the methods according to exemplary embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, an embodiment of the present invention may be implemented in the form of a module, a procedure, a function, etc. Software code may be stored in a memory unit and executed by a processor. The memory unit is located at the interior or exterior of the processor and may transmit and receive data to and from the processor via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

And, both an apparatus invention and a method invention are explained in the present specification and the explanation on both of the inventions can be complementally applied, if necessary.

### INDUSTRIAL APPLICABILITY

Although the present invention explains a method for a device to establish an ASP session in a wireless communication system, the method can be applied to various wireless communication systems.

What is claimed is:

1. A method of establishing an application service platform (ASP) session established by a first device in a wireless communication system, the method comprising:
establishing an ASP session for a first service configured by a first network type, with a second device based on a P2P connection method;
performing a feature capability exchange procedure with the second device; and
establishing an ASP session for a second service with the second device,
wherein the feature capability exchange procedure is completed when the first device transmits a feature capability request message to the second device and receives a feature capability response message from the second device based on the established ASP session for the first service, and
wherein the feature capability request message and the feature capability response message comprise network type information on the second service.

2. The method of claim 1, wherein the feature capability request message comprises the network type information capable of being supported by the first device and,
wherein the feature capability response message comprises the network type information to be used by the second device based on the feature capability request message.

3. The method of claim 1, wherein the feature capability request message and the feature capability response message are performed in a state that a service discovery for the second service is completed.

4. The method of claim 1, wherein a network type is configured by either a first network type or a second network type, and
wherein the network type is determined based on whether or not the network type operates based on an IP (internet protocol).

5. The method of claim 1, wherein the feature capability request message and the feature capability response message are defined based on an ASP coordination protocol (ASP CP) message format.

6. The method of claim 1, wherein the feature capability exchange procedure is omitted when the network type information is contained in a message exchanged between the first device and the second device to establish the ASP session for the second service.

7. The method of claim 6, wherein the message exchanged to establish the ASP session corresponds to either a version message or a session request message.

8. The method of claim 1, wherein the ASP session for the second service is established based on either the P2P connection method or a WLAN infrastructure connection method.

9. The method of claim 8, wherein the first device and the second device omit additional authentication and an association procedure and establish the ASP session for the second service based on the feature capability exchange procedure when the ASP session for the second service is established based on the WLAN infrastructure connection method.

10. The method of claim 1, further comprising the step of establishing an ASP session for a third service with a third device as a second network type based on the P2P connection method.

11. The method of claim 10, wherein the first device corresponds to a P2P group owner device.

12. The method of claim 11, wherein the first device transmits a message containing information on the network type to the second device and the third device before the ASP session for the first service and the ASP session for the third service are established.

13. The method of claim 11, wherein the first device performs a negotiation procedure for determining the network type with each of the second device and the third device before the ASP session for the first service and the ASP session for the third service are established.

14. The method of claim 1, further comprising the step of establishing an ASP session for a third service with a third device as a second network type based on a WLAN infrastructure connection method.

15. A first device establishing an application service platform (ASP) session in a wireless communication system, comprising:
a reception module configured to receive information from an external device;
a transmission module configured to transmit information to an external device; and
a processor configured to control the reception module and the transmission module,
wherein the processor is further configured to:
establish an ASP session for a first service, which is configured by a first network type, with a second device based on a P2P connection method,
perform a feature capability exchange procedure with the second device, configured to establish an ASP session for a second service with the second device,
wherein the feature capability exchange procedure is completed when the first device transmits a feature capability request message to the second device and receives a feature capability response message from the second device based on the established ASP session for the first service, and
wherein the feature capability request message and the feature capability response message comprise network type information on the second service.
